(19) United States
(12) Patent Application Publication
(10) Pub. No.: US 2023/0145794 A1
(43) Pub. Date: May 11, 2023

(54) SOLVENT COMPOSITIONS PROMOTING PLANT GROWTH

(71) Applicant: WinField Solutions, LLC, Arden Hills, MN (US)

(72) Inventors: Dustyn Sawall, River Falls, WI (US); Cliff Watrin, Wyoming, MN (US); Catherine E. White, River Falls, WI (US); Shelby Stark, River Falls, WI (US); Marcus Jones, Ankeny, IA (US)

(73) Assignee: WinField Solutions, LLC, Arden Hills, MN (US)

(21) Appl. No.: 17/980,764

(22) Filed: Nov. 4, 2022

Related U.S. Application Data
(60) Provisional application No. 63/276,137, filed on Nov. 5, 2021.

(51) Int. Cl. A01N 25/02; A01N 45/00; A01N 43/90; A01N 43/38

(52) U.S. Cl. CPC A01N 25/02; A01N 45/00; A01N 43/90; A01N 43/38

(57) ABSTRACT

Plant growth composition and methods of using plant growth compositions including a solvent composition including propylene glycol and 2-butoxy ethanol and an active component combination formulated to increase growth of a plant. The composition solvent composition may include about 50% or more propylene glycol and about 50% or less 2-butoxy ethanol such as about 50% to about 90% propylene glycol and about 10% to about 50% 2-butoxy ethanol. The plant growth composition may be applied to plant seeds prior to growing the plant seeds into mature plants.

### TECHNICAL FIELD

Implementations relate to inert compositions formulated for use with plant growth regulator compositions typically applied to seeds and nascent plants.

### BACKGROUND

Improving plant growth and development is a major focus of the agricultural industry. One approach to achieving robust growth involves applying growth stimulants to seeds and young plants. These substances may include plant growth regulators (“PGRs”), which can comprise combinations of plant hormones that promote cellular growth processes like mitosis, and other substances including, for example, biostimulants, biologicals and plant extracts. These PGRs can be applied to seeds before planting, in-furrow during or after planting, or as foliar sprays applied to the plants as they grow. To facilitate these application methods, PGRs are often dissolved in a liquid carrier, which typically comprises an aqueous solvent. However, some preexisting liquid carriers suffer many drawbacks, however, which reduce the lifespan and effectiveness of the active PGR components. For example, certain PGR active components have low solubility in current solvents, and many solvents even chemically degrade the active components they are formulated to deliver. Alternative, non-aqueous based solvents may also hinder the effectiveness of seed-applied compositions by reducing seed handling properties.

### SUMMARY

In accordance with embodiments of the present disclosure, a plant growth composition may include a solvent composition and an active component combination. The solvent composition may include propylene glycol, 1-methoxy-2-propanol, glyceryl triacetate, methyl isobutyl ketone, 2-butoxy ethanol, ethyl acetate, butyl lactate, lactic acid and/or n-butyl pyrrolidone. Some compositions include propylene glycol and 2-butoxy ethanol, either alone or in combination with other solvents. The active component combination may be formulated to increase the growth of a plant.

In some examples, the active component combination can include an amount of auxin, an amount of gibberellin, an amount of cytokinin, or a combination thereof. In some embodiments, the solvent composition can exclude butanol. In some examples, the solvent composition can exclude citric acid. In some embodiments, the solvent composition can exclude lactic acid. In some embodiments, the solvent composition can exclude biodegradable polymers, polyhydric alcohols, or both. In some embodiments, the solvent composition can constitute between about 95 wt % and about 99 wt % of the plant growth composition. In some examples, the solvent composition can be compatible with a plant growth-promoting microbe, such as Rhizobia. In some embodiments, the active component combination can be completely soluble within the solvent composition. In some examples, the active component combination may not degrade within the solvent composition for at least about 2 weeks at about 54° C. In some examples, the plant growth composition can be configured for direct application to plant seeds.

In accordance with embodiments of the present disclosure, a method of improving plant growth can involve applying a growth composition to plant seeds and growing the plant seeds into mature plants. The growth composition can include a solvent composition and an active component combination. The solvent composition can include propylene glycol, 2-bytoxy ethanol, 1-methoxy-2-propanol, glyceryl triacetate, methyl isobutyl ketone, 2-bytoxy ethanol, ethyl acetate, butyl lactate, lactic acid and/or n-butyl pyrrolidone.

In some examples, the plants include soybean plants, corn plants, wheat plants, barley plants, alfalfa plants, or combinations thereof. In some embodiments, the active component combination can include an amount of auxin, an amount of gibberellin, an amount of cytokinin, or a combination thereof. In some examples, the solvent composition can exclude butanol, citric acid, lactic acid. In some embodiments, the boiling point of the solvent composition can be at least about 100° C. and less than about 180° C. In some examples, the solvent composition can be compatible with Rhizobia.

### BRIEF DESCRIPTION OF THE DRAWINGS

FIG. 1 is a flow diagram of a method performed in accordance with principles of the present disclosure.

### DETAILED DESCRIPTION

The solvent compositions provided herein can promote plant growth and development by improving the solubility and stability of various PGR compositions, and may be optimized for direct seed application. The solvent compositions may also protect bacteria capable of naturally enhancing plant growth, such as Rhizobia, in sharp contrast to preexisting solvent compositions that are often harmful to such bacterial species. Embodiments of the inert solvent compositions disclosed herein can include, for example, 1-methoxy-2-propanol, glyceryl triacetate, methyl isobutyl ketone, 2-butoxy ethanol, ethyl acetate, butyl lactate, lactic acid, n-butyl pyrrolidone, butanol, propylene glycol, or combinations thereof. For example, in some embodiments, the solvent composition includes a combination of propylene glycol and 2-butoxy ethanol, either as the only solvents or in combination with other solvents for improved plant and root growth characteristics as compared to compositions including other solvents including solvents which exclude propylene glycol. The disclosed compositions have been identified and modified for promoting growth by experimentally assessing the impact of various solvent combinations on an assortment of PGR compositions and concentrations. Such assessments revealed that the disclosed compositions may be more compatible with the PGR active components, such that the active components do not degrade, thereby prolonging shelf life and maximizing field effects.

Some implementations of the disclosed solvent compositions configured for seed-applied application may reduce or replace water, while other implementations may include water. In some compositions, water solutions may be chemically unstable, which may accelerate decomposition of a range of PGR components.

In some embodiments, the solvent includes propylene glycol and 2-butoxyethanol. For example, the solvent composition may comprise between about 10% and about 90% propylene glycol, or between about 20% and about 80% propylene glycol, or between about 30% and about 70% propylene glycol, and may further comprise between about 10% and about 90% 2- butoxy ethanol, or between about 20% and about 80% 2-butoxy ethanol, or between about 30% and about 70% 2-butoxy ethanol. For example, in some embodiments, the solvent composition may comprise about 50% of greater propylene glycol, such as about 50% to about 90% propylene glycol, and 50% or less 2-butoxy ethanol, such as about 50% to about 10% 2-butoxy ethanol. More specifically, some compositions may comprise about 50% propylene glycol and about 50% 2-butoxy ethanol, about 60% propylene glycol and about 40% 2-butoxy ethanol, about 70% propylene glycol and about 30% 2-butoxy ethanol, about 80% propylene glycol and about 20% 2-butoxy ethanol, or about 90% propylene glycol and about 10% 2-butoxy ethanol. In some embodiments, the solvent composition may comprise about 70% to about 80% propylene glycol and about 20% to about 30% 2-butoxy ethanol, such as about 75% propylene glycol and about 25% 2-butoxy ethanol.

The disclosed solvent compositions may be mixed with one or more additional components, and may be advantageously compatible with such products, which may include one or more herbicides, insecticides, fungicides, beneficial bacteria, or combinations thereof. Additives and/or dyes may also be included.

The inventive solvent compositions disclosed herein may be chemically inert, meaning the compositions do not drive growth of the plant seeds to which they are applied, but rather facilitate effective application, stability and solubility of the active components that do drive plant growth.

### Solvent Compositions

The compositions provided according to the present disclosure include various amounts of inert compounds, which may include but are not limited to propylene glycol, 1-methoxy-2-propanol, glyceryl triacetate, methyl isobutyl ketone, 2-bytoxy ethanol, ethyl acetate, butyl lactate, lactic acid, n-butyl pyrrolidone and/or butanol. Example compositions may include 1-methoxy-2-propanol, ethylene glycol butyl ether, diethylene glycol butyl ether, lactic acid, tetrahydrofurfyl alcohol, and/or butyl lactate, and/or variations of one or more of these compounds.

The concentration of the aforementioned solvent components may vary within a given solvent composition. For example, embodiments may also include mixtures of one or more of the aforementioned solvents with various amounts of deionized water, for example up to about 25 wt % or 50 wt % deionized water, such that solvent compositions can include at least about 75 wt % or 50 wt % pure solvent, respectively. Embodiments may also lack water entirely, rendering such embodiments non-aqueous. In various embodiments, a solvent composition may include about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, about 98 wt %, about 99 wt %, or about 100 wt % of one or more the pure solvents disclosed in the preceding paragraph.

Embodiments of the solvent compositions containing less than about 100 wt % of the disclosed solvent components may include an amount of water, as mentioned. Embodiments may also include an amount of one more solvents such as propylene glycol or polypropylene glycol. In some embodiments, a disclosed solvent composition may be combined with a preexisting solvent composition to form a solvent mixture. The solvent mixture may be applied to seeds before planting.

Embodiments of the disclosed solvent compositions may specifically exclude one or more components. For example, embodiments may specifically exclude butanol. In addition or alternatively, embodiments may exclude citric acid and/or lactic acid. Embodiments may also lack biodegradable polymers, such as a citrate polymer. Embodiments may also be non-polymerized entirely, such that the seed coatings comprised of the disclosed solvent compositions may be free of polymer-based substances. Example compositions may also be free of C2 to C6 polyhydric alcohols, such as glycerol. The inclusion of one or more of these components may reduce or drastically diminish the advantageous physical and chemical properties of the solvent compositions disclosed herein, such that their exclusion from one or more embodiments may be useful for effectively promoting plant growth.

The solvent compositions disclosed herein may also include additional inactive components in the form of adjuvants, excipients and/or surfactants, which may be formulated to improve the effectiveness of the active components with which the solvent compositions are mixed by acting as compatible diluents and/or carrier substances. One or more anti-oxidant(s), such as butylated hydroxytoluene (BHT), and/or preservatives may also be included. According to such embodiments, the disclosed solvents may constitute the majority of the total solvent composition, ranging in embodiments from about 85 to about 99.9 wt %, about 90 to about 99.8 wt %, about 95 to about 99.8 wt %, about 98 to about 99.8 wt %, about 99 to about 99.7 wt %, about 99.5 to about 99.8 wt %, or about 99.6 to about 99.7 wt % by weight of the solvent composition. In some implementations, the solvent composition may be free of other solvents not disclosed herein.

In some embodiments, the solvent compositions may have a relatively lower boiling point. For example, the boiling point of the solvent compositions may range from at least about 100° C. up to about 180° C. Example boiling points may be about 100° C. or less, or about 110° C., 120° C., 130° C., 140° C., 150° C., 160° C., 170° C. or about 180° C. However, in other embodiments, the solvent compositions may have relatively higher boiling points, such as greater than about 180° C.

The solvent compositions described herein may be compatible with various growth-stimulating compositions (collectively referred to as “PGR compositions” herein), meaning the solvent compositions do not interfere with or negatively impact the PGR compositions. The PGR compositions may be formulated for one or more plant types, including but not limited to soybeans, corn (maize), wheat, barley, alfalfa, and other crops. Corn plants may include Zea mays hybrids, inbreds, haploids, subspecies and varieties. In some examples, one or more of the aforementioned plant types may be excluded from the embodiments disclosed herein.

The PGR compositions dissolved within the disclosed solvent compositions are configured to stimulate plant growth to a greater extent than can be achieved under natural growth conditions. Enhanced growth may be achieved by applying one or more of the disclosed PGR compositions to plant seeds prior to planting. By enhancing the stability and solubility of the PGR compositions, the disclosed solvent compositions can maximize the plant-promoting effects of the PGR compositions. For example, the disclosed solvent compositions may remain chemically and physically stable for at least two weeks after mixing with a PGR composition. Fast curing and smooth application of the solvent compositions can also ensure that the seeds are entirely or substantially coated with a growth composition comprised of at least one PGR composition dissolved in a solvent composition. The PGR compositions disclosed herein can include an active component combination that includes at least one auxin (e.g., indole-3-butyric acid (IBA)), at least one gibberellin (e.g., G4, G7 or both), and/or at least one cytokinin (e.g., kinetin).

Auxin plant hormones are produced mainly in and around growing regions on plant shoots. Auxins typically move from the shoots and roots in the phloem, and more slowly by cell-to-cell polar transport. Example effects elicited by auxins include apical dominance, tropisms, shoot elongation and root initiation. Natural deficiencies of zinc and/or phosphorus may inhibit auxin production in plants. Gibberellin plant hormones are also produced in root tips, and can be found in seeds, young stems and leaves. Gibberellins move from roots to shoots in the xylem and from leaves to shoots by cell-to-cell transport, promoting plant germination and cell elongation. Gibberellin production in plant roots and gibberellin movement to plant shoots can be inhibited by flooding. Cytokinin plant hormones are produced primarily in root tips. Seeds, young stems and leaves also may contain high levels of cytokinins, which are transported through the xylem from the roots to the shoots of a plant. Cytokinins promote cell division in shoot tissue, delay leaf senescence, and promote nodule development. Flooding, drought and high temperatures can inhibit cytokinin production and transport. Accordingly, the PGR components disclosed herein supplement these natural plant hormones and may drive specific physiological processes and may be inhibited by specific environmental phenomena.

### Methods of Formulation

Methods of formulating the solvent compositions disclosed herein can involve conducting one or more mixture experiments. In some examples, a mixture experiment can be designed to systematically evaluate the stability and/or solubility of various PGR compositions in differently formulated solvent compositions. The active component load of a given PGR composition may be adjusted from one experiment to the next. For example, the concentration of auxin, gibberellin and/or cytokinin present within a solvent composition may be increased by 2X, 3X, 4X or 5X. Increasing the active component load may advantageously reduce the volume of PGR composition required to achieve improved plant growth.

Embodiments may involve mixing a PGR composition with a solvent composition and determining the solubility and/or stability of the PGR composition within the solvent composition. Solubility and/or stability may be determined visually or with the aid of an analytical device, such as a high performance liquid chromatography column. After mixing the solvent composition with a PGR composition, embodiments may further involve applying the resulting composition to plant seeds, which may then be germinated and grown to maturity. The growth effects attributed to a given solvent composition may be identified by also growing seeds coated with the same PGR composition but a different solvent composition.

Embodiments may also involve performing a root scan of the plants grown from seeds coated with one of the disclosed solvent compositions. Root scanning may be performed using a WinRHIZO™ root scanner, which is configured to measure root density, architecture, surface area, length, diameter, area, volume, topology and/or color caused by a particular PGR composition. A root scan can involve removing the roots from the bottom of each plant stem. The roots from each plant can be scanned simultaneously according to some root scanning protocols.

The solvent composition most compatible with one or more PGR compositions can be identified. In some embodiments, compatibility may be measured by degree of PGR solubility within a solvent composition and/or the length of time at which a PGR composition remains stable (i.e., does not degrade) within a solvent composition. A solvent composition may also be selected based on its compatibility with one or more plant growth-promoting microbes, such as Rhizobia. Microbial compatibility may be measured by the extent of microbial death caused by exposure to a solvent composition and/or the extent of root growth caused by planting seeds treated with a PGR composition dissolved within a given solvent composition. In the latter case, more comprehensive root growth may be indicative of greater microbial compatibility. For example, Rhizobia can excrete nodulation factors that drive root nodule development, which may subsequently lead to extensive root hair growth. Microbial compatibility may also be determined by streaking one or more microbes of interest on a cell culture plate containing a growth medium, e.g., agar, infused with a solvent composition.

### Methods of Use

Methods of improving plant growth can involve applying a plant growth composition comprising a PGR composition dissolved within one of the disclosed solvent compositions to plant seeds. The volume of the plant growth composition applied to the seeds can be sufficient to coat the seeds and eventually drive improved plant growth, development and/or yield. The solvent composition may be formed by combining 1-methoxy-2-propanol, glyceryl triacetate, methyl isobutyl ketone, 2-bytoxy ethanol, ethyl acetate, butyl lactate, lactic acid, n-butyl pyrrolidone and/or propylene glycol with an active component combination comprising an amount of auxin, an amount of gibberellin, an amount of cytokinin, or a combination thereof.

The plant growth composition, comprising a solvent composition and an active component composition dissolved therein, may be sprayed or otherwise coated onto plant seeds prior to planting. The plant growth composition may be applied to seeds in production settings and then the seeds may be provided to a planting site, or the plant growth composition may be applied to the seeds at the planting site. Usage rates may vary depending on the particular compositions used and/or the plant type. For example, the active component loading rate may range from about 1.05 to about 4.2 fl. oz. per hundredweight (cwt.) for direct seed treatment. In some examples, the active component loading rate may be about 2.1 fl. oz./cwt. In additional embodiments, the active component loading rate may be decreased to about 1.5 fl. oz./cwt., about 1.0 fl. oz./cwt., about 0.75 fl. oz./cwt., about 0.5 fl. oz./cwt., or between about 0.1 and about 0.5 fl. oz./cwt. Embodiments including an active component loading rate below 2.1 fl. oz./cwt. may include a greater concentration of one or more active components. For example, the concentration of the active component combination may be about 4X for a growth composition loading rate of about 0.5 fl. oz./cwt. relative to the concentration of the active component combination included in a growth composition having a loading rate of about 2.1 fl. oz./cwt. By reducing the loading rate to about 0.5 fl. oz./cwt., the volume of plant growth composition expended per acre may be advantageously decreased without reducing its effectiveness at enhancing plant growth.

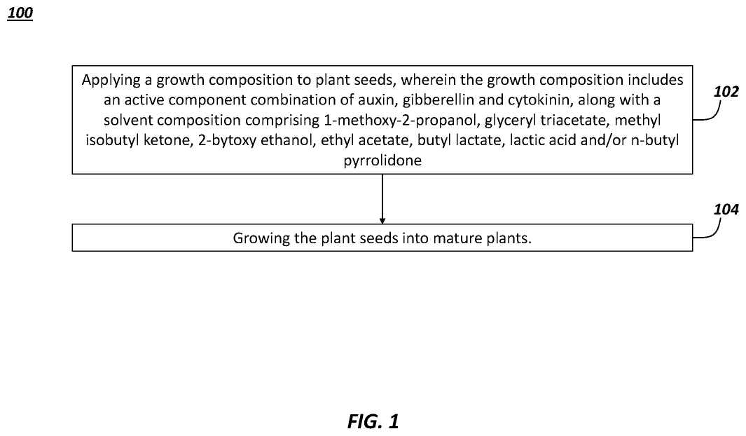

FIG. 1 is a flow diagram of a method of improving plant growth performed in accordance with principles of the present disclosure. The example method 100 shows the steps that may be implemented, in any sequence, to improve plant growth and/or development by applying a solvent composition mixed with an active component combination to plant seeds prior to planting. In additional examples, one or more of the steps shown in the method 100 may be supplemented or omitted.

In the embodiment shown, the method 100 begins at block 102 by “applying a growth composition to plant seeds, wherein the growth composition includes an active component combination of auxin, gibberellin and cytokinin, along with a solvent composition comprising propylene glycol, 1-methoxy-2-propanol, glyceryl triacetate, methyl isobutyl ketone, 2-bytoxy ethanol, ethyl acetate, butyl lactate, lactic acid and/or n-butyl pyrrolidone.” The method 100 continues at block 104 by “growing the plant seeds into mature plants.” In some examples, the plant seeds can include soybean seeds, corn seeds, wheat seeds, barley seeds, alfalfa seeds, or combinations thereof. In some examples, mature plants may be defined as plants that reach the V3, V6, V9, VT, R1 or R6 growth stage, or any stage therebetween. Embodiments of the solvent composition may specifically exclude butanol, citric acid, lactic acid, biodegradable polymers, polyhydric alcohols and/or water. In some examples, the boiling point of the solvent composition is at least about 100° C. and less than about 180° C., while in other embodiments the boiling point is greater than about 180° C. The solvent composition can be compatible with various plant growth-promoting microbes, such as Rhizobia. In another embodiment, the seeds may have the growth composition applied as a seed dressing or a seed coating and may be a seed product, and the seed product may be grown to maturity in step 104.

Applying the plant growth compositions to plant seeds according to the methods described herein may cause improvements in plant growth. For example, plant seeds treating with a disclosed plant growth composition may result in mature plants having increased plant height and/or leaf turgidity. Increases in total dry plant biomass relative to plants treated with a negative control may also be observed.

### EXPERIMENTAL

### Example 1

Sequential experiments were performed to characterize the physical and chemical properties of various solvent compositions. Certain solvent compositions were then selected for continued analysis to identify the compositions most compatible with an assortment of PGR compositions, with an emphasis on PGR stability and solubility.

First, the physical properties of various known solvents and solvent combinations were documented by reviewing the Safety Data Sheet (“SDS”) for each solvent. Information gleaned from each SDS included the flash point, boiling point, density, viscosity and solubility.

The solvents initially examined included ethyl acetate, 1-methoxy-2-propanol, ethylene glycol butyl ether and 2-butoxyl ethanol, diethylene glycol butyl ether, lactic acid and 2-ethylhexyl ester, tetrahydrofurfyl alcohol, ethyl hexanol, butyl lactate, propylene glycol, polypropylene glycol, oxo-octyl acetate, glyceryl triacetate, oxo-heptyl acetate, amyl acetate, Hallcomid® M-8-10, and Hallcomid® 1025. Data for the 16 documented solvents, where available, are shown below in Table 1.

TABLE 1

| | | Flash | Boiling | Density |
|---|---|---|---|---|
| Comp. | Solvent | Point (C. °) | Point (C. °) | (g/mL) |
| 1 | Ethyl acetate | −4.4 | 77 | 1.049 |
| 2 | 1-methoxy-2- | 34 | 118 | 0.942 |
| | propanol | | | |
| 3 | Ethylene glycol | 60 | 171 | 0.902 |
| | butyl ether, 2- | | | |
| | butoxyl ethanol | | | |
| 4 | Diethylene | 78 | 228 | 0.967 |
| | glycol butyl | | | |
| | ether | | | |
| 5 | Lactic acid, 2- | 110 | 122 | 1.209 |
| | ethylhexyl ester | | | |
| 6 | Tetrahydrofurfyl | 84 | 178 | 1.054 |
| | Alcohol | | | |
| 7 | Ethyl hexanol | 73 | 185 | 0.833 |
| 8 | Butyl lactate | 76 | 186 | 0.984 |
| 9 | Propylene | 101 | 205 | 1.036 |
| | Glycol | | | |
| 10 | Polypropylene | 101 | 287 | 1.036 |
| | Glycol | | | |
| 11 | Oxo-octyl | 86 | 211 | 0.867 |
| | acetate | | | |
| 12 | Glyceryl | 138 | 259 | 1.160 |
| | triacetate | | | |
| 13 | Oxo-heptyl | 43 | 192 | 0.886 |
| | acetate | | | |
| 14 | Amyl Acetate | 32 | 149 | 0.876 |
| 15 | Hallcomid ® M- | 118 | 250 | 0.879 |
| | 8-10 | | | |
| 16 | Hallcomid ® | 134 | 297 | 0.740 |
| | 1025 | | | |

*ND = Not Determined

As shown, several known solvents have boiling points above 200° C., including propylene glycol, polypropylene glycol, diethylene glycol butyl ether, glyceryl triacetate, oxo-octyl acetate, Hallcomid® M-8-10, and Hallcomid® 1025. Select solvents have boiling points between about 110° C. and about 180° C., including 1-methoxy-2-propanol, ethylene glycol butyl ether, tetrahydrofurfyl alcohol, and amyl acetate. The flash points of several solvents are above 115° C., including propylene glycol, glyceryl triacetate, Hallcomid® M-8-10, and Hallcomid® 1025. Multiple solvents are soluble, including 1-methoxy-2-propanol, lactic acid, 2-ethylhexyl ester, propylene glycol and glyceryl triacetate.

Various solvent compositions were then selected for continued analysis with various active components combinations formulated to enhance plant growth. In particular, each selected solvent composition was mixed with a PGR composition comprising cytokinin, gibberellin and auxin, and the solubility level of each PGR composition within each solvent composition determined.

Some of the PGR compositions were provided at an active component loading rate of 4X relative to a 1x loading rate of 2.1 fl. oz./cwt. For the 4X PGR compositions, the rate was adjusted to 0.5 fl. oz./cwt. to accommodate the flow meter properties of the seed treatment equipment that is typically used. Table 2 shows the active component loading at 2.1 fl. oz./cwt. and the adjusted rate of active components at 0.5 fl. oz./cwt., with each active component loading indicated by its weight percentage in the PGR composition (including the solvent).

TABLE 2

| Comp. | Loading Rate | Cytokinin | Auxin | Gibberellin |
|---|---|---|---|---|
| 1X | 2.1 fl. oz./cwt. | 0.0239% | 0.1262% | 0.0205% |
| 4X | 0.5 fl. oz./cwt. | 0.0955% | 0.5049% | 0.0819% |

Based on their favorable physical properties and solubility data, several solvent compositions were selected for additional analysis. Each selected solvent composition was mixed with 0.1 wt % butylated hydroxytoluene (“BHT”) and a 4X PGR composition. Propylene glycol was used as a control. The evaluated solvents, along with the mass of each PGR component and BHT, are shown below in Table 3.

TABLE 3

| Solvent | Cytokinin (g) | Gibberellin (g) | Auxin (g) | BHT (g) |
|---|---|---|---|---|
| tetrahydrofurfyl | 0.0952 | 0.0802 | 0.4841 | 0.1068 |
| alcohol | | | | |
| polyethylene | 0.0989 | 0.0832 | 0.4740 | 0.1254 |
| glycol | | | | |
| 1-methoxy-2- | 0.0927 | 0.0808 | 0.4874 | 0.1890 |
| propanol | | | | |
| diethylene | 0.0928 | 0.0841 | 0.4828 | 0.0990 |
| glycol butyl | | | | |
| ether | | | | |
| butyl lactate | 0.1065 | 0.0902 | 0.5347 | 0.1124 |
| polypropylene | 0.0978 | 0.0876 | 0.4970 | 0.1189 |
| glycol | | | | |
| ethylene glycol | 0.0920 | 0.1033 | 0.4809 | 0.1127 |
| butyl ether | | | | |

The density and viscosity of the solvent compositions were then determined. The density measurements were obtained using a DMA™ 4500, which was calibrated using 20° C. DI water. Viscosity was determined using a modular compact rheometer. Viscosity levels were measured at 25° C. Twenty data points were collected over a period of two minutes, and the average of these data points recorded as the viscosity.

As shown below in Table 4, 1-methoxy-2-propanol, diethylene glycol butyl ether, butyl lactate and ethylene glycol butyl ether each had a density measuring less than 1.00 g/mL. The viscosities of polyethylene glycol and polypropylene glycol were the greatest by a wide margin, and the viscosity of 1-methoxy-2-propanol was the lowest.

TABLE 4

| | Density | Viscosity |
|---|---|---|
| Solvent | (g/mL) | (cPa) |
| tetrahydrofurfyl | 1.0548 | 5.4046 |
| alcohol | | |
| polyethylene glycol | 1.1235 | 51.246 |
| 1-methoxy-2-propanol | 0.9215 | 2.3243 |
| diethylene glycol | 0.9524 | 7.7338 |
| butyl ether | | |
| butyl lactate | 0.9823 | 5.0736 |
| polypropylene glycol | 1.0358 | 51.107 |
| ethylene glycol butyl | 0.8999 | 6.8808 |
| ether | | |

To understand if changing the active component loading rate would impact the biological performance of the PGR compositions, two solvent compositions, methoxy propanol and tetrahydrofurfyl alcohol, were mixed with various PGR compositions (4X) selected for their favorable solubility properties, curing properties, and compatibility with Rhizobia. Propylene glycol was again included as a control sample, and each composition was mixed with BHT (4X). Citric acid was excluded from all samples. The weight percentage of each PGR component mixed with each solvent composition is shown below in Table 5.

TABLE 5

| Solvent | Cytokinin (g) | Gibberellin (g) | Auxin (g) |
|---|---|---|---|
| methoxy propanol | 0.0614% | 0.0460% | 0.6596% |
| methoxy propanol | 0.1074% | 0.0460% | 0.6136% |
| methoxy propanol | 0.1534% | 0.0920% | 0.5215% |
| methoxy propanol | 0.1994% | 0.0690% | 0.4985% |
| methoxy propanol | 0.1074% | 0.0920% | 0.5675% |
| tetrahydrofurfyl | 0.094% | 0.0804% | 0.4958% |
| alcohol | | | |
| polypropylene glycol | 0.0955% | 0.0819% | 0.5049% |

Active ingredient loading of each PGR component was then measured via high performance liquid chromatography (“HPLC”) to ensure the active components do not chemically decompose in the novel solvent compositions. The HPLC was performed using an Agilent 1260 device with a diode-array detector for active component quantification.

The percentage variation between the amount of each active component originally added to the solvent composition and the amount of each active component remaining after HPLC is indicated below in Table 6. As shown, the deviation was less than 1% for each composition.

TABLE 6

| | methoxy | methoxy | methoxy | methoxy | methoxy | tetrahydrofurfyl | polypropylene |
|---|---|---|---|---|---|---|---|
| | propanol | propanol | propanol | propanol | propanol | alcohol | glycol |
| Cyt. (g) | 0.072% | 0.126% | 0.178% | 0.235% | 0.130% | 0.108% | 0.116% |
| Gib. (g) | 0.046% | 0.045% | 0.088% | 0.069% | 0.089% | 0.081% | 0.080% |
| Aux. (g) | 0.674% | 0.630% | 0.531% | 0.502% | 0.579% | 0.497% | 0.523% |

The experimental results summarized above indicate that various embodiments of PGR compositions exhibit improved chemical stability and increased solubility in several of the solvent compositions disclosed herein.

### Example 2

Additional experiments were performed to characterize the physical and chemical properties of various other solvent compositions in combination with an assortment of PGR compositions. Certain solvent compositions were then selected for continued analysis to identify the compositions most compatible with an assortment of PGR compositions.

The physical properties of the various solvents and solvent combinations in combination with the assortment of PGR compositions were determined using standard laboratory equipment. Flash point was determined using a flashpoint tester.

The solvents initially examined included 2-butoxy ethanol (“BE”), BHT, propylene glycol (“PG”), methoxy propanol, water, polyethelene glycol (“PEG”), and Tetrahydrofurfyl alcohol (“THFA”), alone and/or in various combinations, with and without PGR compositions including Kinetin, indole butyric acid (“IBA”) and gibberellin A4 (“GA4”). Data for the 42 compositions, where available, are shown below in Table 7.

TABLE 7

| | | | Kinetin | IBA | GA4 | Flash | | |
|---|---|---|---|---|---|---|---|---|
| | | | Loading | Loading | Loading | Point | | Density |
| Comp | Solvent | Ratio | (wt %) | (wt %) | (wt %) | (C°) | pH | (g/mL) |
| 1 | 2-butoxy | 86/14 | 0.012 | 0.1028 | 0.0619 | 165.6 | 4.67 | 0.9636 |
| | ethanol | | | | | | | |
| 2 | 2-butoxy | 75/25 | 0.0123 | 0.1026 | 0.0615 | 178 | 4.64 | 1.000 |
| | ethanol | | | | | | | |
| 3 | 2-butoxy | 50/50 | 0.0124 | 0.1028 | 0.0618 | 171 | 4.56 | 1.016 |
| | ethanol | | | | | | | |
| 4 | 0.5wt % BHT | 86/14 | 0.0126 | 0.1023 | 0.0618 | ND* | ND | |
| 5 | 0.1wt % BHT | 86/14 | 0.0126 | 0.1023 | 0.0618 | ND | ND | |
| 6 | 0.025wt % BHT | 86/14 | 0.0126 | 0.1023 | 0.0618 | ND | ND | |
| 7 | 0.5wt % BHT | 75/25 | 0.0125 | 0.101 | 0.0618 | ND | ND | |
| 8 | 0.1wt % BHT | 75/25 | 0.0125 | 0.101 | 0.0618 | ND | ND | |
| 9 | 0.025wt % BHT | 75/25 | 0.0125 | 0.101 | 0.0618 | ND | ND | |
| 10 | 0 BHT | 75/25 | 0.0125 | 0.101 | 0.0618 | ND | ND | |
| 11 | AGM21012, | 50/50 | 0.0126 | 0.1027 | 0.0617 | ND | ND | |
| | 0.5wt % BHT | | | | | | | |
| 12 | 0.1wt % BHT | 50/50 | 0.0126 | 0.1027 | 0.0617 | ND | ND | |
| 13 | 0.025wt % BHT | 50/50 | 0.0126 | 0.1027 | 0.0617 | ND | ND | |
| 14 | PG/BE | 14/86 | 0.012 | 0.1084 | 0.0656 | 152 | 4.21 | 0.9192 |
| 15 | PG/BE | 28/72 | 0.0146 | 0.1034 | 0.0628 | 157 | 4.35 | 0.9366 |
| 16 | PG/BE | 50/50 | 0.0123 | 0.1012 | 0.0626 | 166 | 4.33 | 0.9663 |
| 17 | PG/BE | 72/28 | 0.0123 | 0.1015 | 0.0621 | 168 | 4.37 | 0.9954 |
| 18 | PG/BE | 86/14 | 0.0133 | 0.1018 | 0.0615 | 175 | 4.42 | 1.014 |
| 19 | PG/BE, no. PGR | 14/86 | N/A | N/A | N/A | 154 | 5.7 | 0.9212 |
| 20 | PG/BE, no PGR | 28/72 | N/A | N/A | N/A | 157 | 5.72 | 0.9359 |
| 21 | PG/BE, no. PGR | 50/50 | N/A | N/A | N/A | 164 | 5.9 | 0.9641 |
| 22 | PG/BE, no PGR | 72/28 | N/A | N/A | N/A | 175 | 6.3 | 0.9976 |
| 23 | PG/BE, no PGR | 86/14 | N/A | N/A | N/A | 177 | 6.43 | 1.014 |
| 24 | PG/BE | 50/50 | 0.000128 | 0.001036 | 0.000615 | 140 | ND | 0.9633 |
| 25 | PG/BE | 75/25 | 0.000121 | 0.001034 | 0.000619 | 130 | ND | 0.9992 |
| 26 | BE/methoxy | 50/50 | N/A | N/A | N/A | 107 | ND | 0.9115 |
| | propanol | | | | | | | |
| 27 | BE/water | 90/10 | 0.00012 | 0.001028 | 0.000616 | 148.8 | ND | 0.9177 |
| 28 | BE/water | 80/20 | 0.000122 | 0.001031 | 0.000614 | 158.6 | ND | 0.9305 |
| 29 | PG/BE/water | 70/20/10 | 0.000124 | 0.001033 | 0.000625 | 154.3 | ND | 1.011 |
| 30 | BE | 100 | 0.003104208 | 0.005027101 | 0.004307153 | 146 | ND | ND |
| 31 | BE/methoxy | 95/5 | N/A | N/A | N/A | ND | ND | ND |
| | propanol | | | | | | | |
| 32 | BE/methoxy | 75/25 | N/A | N/A | N/A | 107 | ND | ND |
| | propanol | | | | | | | |
| 33 | BE/methoxy | 50/50 | N/A | N/A | N/A | 107 | ND | ND |
| | propanol | | | | | | | |
| 34 | methoxy | 75/25 | N/A | N/A | N/A | 115 | ND | N/A |
| | propanol/water | | | | | | | |
| 35 | methoxy | 50/50 | N/A | N/A | N/A | 127 | ND | ND |
| | propanol/water | | | | | | | |
| 36 | methoxy | 95/5 | N/A | N/A | N/A | 100 | ND | ND |
| | propanol/PG | | | | | | | |
| 37 | methoxy | 75/25 | N/A | N/A | N/A | 122 | ND | ND |
| | propanol/PG | | | | | | | |
| 38 | methoxy | 50/50 | N/A | N/A | N/A | 115 | ND | ND |
| | propanol/PG | | | | | | | |
| 39 | methoxy | 75/25 | N/A | N/A | N/A | 107 | ND | ND |
| | propanol/PEG | | | | | | | |
| 40 | methoxy | 100 | N/A | N/A | N/A | 89 | ND | ND |
| | propanol | | | | | | | |
| 41 | THFA | 100 | N/A | N/A | N/A | 183 | ND | ND |
| 42 | Propylene | 100 | 0.000124 | 0.001025 | 0.000619 | 235 | ND | 1.04 |
| | Glycol | | | | | | | |

*ND = Not Determined

Scintillation vial testing was then performed on several of the compositions listed above using corn plants. Plant length, root appearance and fresh biomass were measured and compared to an untreated control. For scintillation testing, soybean plants were grown in a growth chamber until 8 days after planting at 80 degrees F. and with 14-hour daylength. The soybean seedlings were then removed from the transplant cell and the below-ground portion was removed at the connection to the seed. The seedlings were then placed in a growth chamber in a dilute solvent and PGR composition for 7 days. The seedlings were grown at 70 degrees F., 50% relative humidity, and low light. The solutions were based upon an application volume of 15 gallons per acre (“GPA”). Three trials were conducted, with each treatment repeated 10 times. Whole plant fresh biomass, the presence of roots, and the above ground length were determined after 7 days of treatment. In this case, the roots were not true roots but rather they emerged from nodes at soil level to replace the removed root system. The results are shown in Table 8 below.

TABLE 8

| | | | Kinetin | IBA | GA4 | Plant | Root | Fresh |
|---|---|---|---|---|---|---|---|---|
| | | | Loading | Loading | Loading | Length | Appearance | Biomass |
| Comp | Solvent | Ratio | (wt %) | (wt %) | (wt %) | (cm) | (0/1)* | (g) |
| control | | | | | | 23.17 | 1 | 1.17 |
| 14 | PG/BE | 14/86 | 0.012 | 0.1084 | 0.0656 | 18 | 0 | 1.53 |
| 15 | PG/BE | 28/72 | 0.0146 | 0.1034 | 0.0628 | 18.5 | 0 | 1.327 |
| 16 | PG/BE | 50/50 | 0.0123 | 0.1012 | 0.0626 | 17.17 | 0 | 1.343 |
| 17 | PG/BE | 72/28 | 0.0123 | 0.1015 | 0.0621 | 16.67 | 0 | 1.143 |
| 18 | PG/BE | 86/14 | 0.0133 | 0.1018 | 0.0615 | 15 | 0 | 1.063 |
| 19 | PG/BE, | 14/86 | N/A | N/A | N/A | 11.33 | 0.7 | 1.14 |
| | no. PGI | | | | | | | |
| 20 | PG/BE, | 28/72 | N/A | N/A | N/A | 9.5 | 1 | 1.09 |
| | no PGI | | | | | | | |
| 21 | PG/BE, | 50/50 | N/A | N/A | N/A | 10.33 | 1 | 0.917 |
| | no. A.I. | | | | | | | |
| 22 | PG/BE, | 72/28 | N/A | N/A | N/A | 9.33 | 1 | 0.98 |
| | no PGI | | | | | | | |
| 23 | PG/BE, | 86/14 | N/A | N/A | N/A | 10.5 | 1 | 0.99 |
| | no PGI | | | | | | | |
| 24 | PG/BE | 50/50 | 0.000128 | 0.001036 | 0.000615 | 22.44 | 0.2 | 0.95 |
| 25 | PG/BE | 75/25 | 0.000121 | 0.001034 | 0.000619 | 22.33 | 0.2 | 0.981 |
| 27 | BE/water | 90/10 | 0.00012 | 0.001028 | 0.000616 | 20.22 | 0 | 0.863 |
| 28 | BE/water | 80/20 | 0.000122 | 0.001031 | 0.000614 | 21.28 | 0.1 | 0.917 |
| 29 | PG/BE/water | 70/20/10 | 0.000124 | 0.001033 | 0.000625 | 21.33 | 0.1 | 0.943 |
| 30 | BE | 100 | 0.003104208 | 0.005027101 | 0.004307153 | kills corn | N/A | N/A |
| 40 | methoxy | 100 | N/A | N/A | N/A | similar | | |
| | propanol | | | | | above ground | | |
| | | | | | | growth and | | |
| | | | | | | biomass | | |
| | | | | | | as control | | |
| 41 | THFA | 100 | N/A | N/A | N/A | similar | | |
| | | | | | | above ground | | |
| | | | | | | growth and | | |
| | | | | | | biomass | | |
| | | | | | | as control | | |
| 42 | Propylene Glycol | 100 | 0.000124 | 0.001025 | 0.000619 | 22.11 | 0.6 | 0.974 |

*Root appearance is binominal with 0 = no roots, 1 = roots present.

Many of the compositions which include a PGR component were also tested for stability. In some of the composition, Butylated Hydroxytoluene (BHT) was included as an anti-oxidant additive. Accelerated storage and stability testing were carried out via placing a sample of the solvent into a sealed, glass jar and exposing it to 54° C. for two weeks in order to simulate accelerated test conditions. Upon removal from the oven, the sample was analyzed via HPLC-UV to assay active ingredient content. The aged sample was compared to the initial sample concentrations to ascertain the degree of degradation. The results are shown below in Table 9.

TABLE 9

| | | | Stability |
|---|---|---|---|
| | | | (Kinetin/ |
| Comp | Solvent | Ratio | IBA/GIB) |
| 1 | Butoxy Ethanol | 86/14 | 1.050%/ |
| | | | 0.977%/1.069% |
| 2 | Butoxy Ethanol | 75/25 | 0.965%/ |
| | | | 0.915%/1.016% |
| 3 | Butoxy Ethanol | 50/50 | 0.986%/ |
| | | | 0.931%/1.034% |
| 14 | Propylene | 14/86 | 0.803%/ |
| | Glycol/Butoxy | | 0.844%/1.026% |
| | Ethanol | | |
| 15 | Propylene | 28/72 | 0.879%/ |
| | Glycol/Butoxy | | 0.883%/0.993% |
| | Ethanol | | |
| 16 | Propylene | 50/50 | 0.861%/ |
| | Glycol/Butoxy | | 0.886%/0.993% |
| | Ethanol | | |
| 17 | Propylene | 72/28 | 0.907%/ |
| | Glycol/Butoxy | | 0.892%/0.999% |
| | Ethanol | | |
| 18 | Propylene | 86/14 | 0.948%/ |
| | Glycol/Butoxy | | 0.900%/1.004% |
| | Ethanol | | |
| 24 | Propylene | 50/50 | 0.963%/ |
| | Glycol/Butoxy | | 0.786%/0.893% |
| | Ethanol | | |
| 25 | Propylene | 75/25 | 0.911%/ |
| | Glycol/Butoxy | | 0.879%/0.945% |
| | Ethanol | | |
| 27 | Butoxy | 90/10 | 0.987%/ |
| | Ethanol/Water | | 0.906%/0.987% |
| 28 | Butoxy | 80/20 | 0.981%/ |
| | Ethanol/Water | | 0.906%/0.945% |
| 29 | Propylene | 70/20/ | 0.996%/ |
| | Glycol /Butoxy | 10 | 0.844%/0.909% |
| | Ethanol/Water | | |

### Example 3

A series of vial assays were performed on corn plants using various solvents and PGR compositions as described below and shown in Table 10. In each case except composition 1, the solvent was combined with 0.0619% gibberellin, 0.0124% cytokinin and 0.1025% indole-3-butyric acid (“IBA”). For each composition, the rate was 0.276% v/v (0.276 mL of each composition was added to 100 mL of water).

In a first set of experiments, corn plants were grown in a growth chamber until 8 days after planting at 80 degrees F. and with 14-hour daylength. The corn seedlings were then removed from the transplant cell and the below-ground portion was removed at the connection to the seed. The seedlings were then placed in a growth chamber in a dilute solvent and PGR composition for 7 days. The seedlings were grown at 70 degrees F., 50% relative humidity, and low light. The solutions were based upon an application volume of 15 gallons per acre (“GPA”). Three trials were conducted, with each treatment repeated 10 times. Whole plant fresh biomass, the presence of roots, and the above ground length were determined after 7 days of treatment. In this case, the roots were not true roots but rather they emerged from nodes at soil level to replace the removed root system.

The results are shown below in Table 10.

TABLE 10

| | | | Above | Root |
|---|---|---|---|---|
| | | Whole Plant | Ground | Presence |
| Comp | Solvent | Biomass (g) | Length (cm) | (%) |
| 1 | Propylene glycol | 1.12 | 22.47 | 87 |
| | (without A.I.) | | | |
| 2 | Propylene glycol | 1.05 | 21.30 | 77 |
| 3 | 2-Butoxy ethanol | 0.94 | 20.17 | 7 |
| 4 | Methoxy | 1.14 | 22.33 | 80 |
| | Propanol | | | |
| 5 | THFA | 1.11 | 22.00 | 13 |

All results were compared by Fisher's LSD at the 95% confidence level with a p value of less than 0.0001.

There was no significant difference in the amount of whole plant biomass among the different compositions except for composition 3, the 2-butoxy ethanol composition, which was statistically less than all the other treatments. The seedling treated with composition 1, the first propylene glycol composition, had a greater biomass than the 2-butoxy ethanol treated seedlings. Similarly, there was no significant difference in the above ground length among the different compositions except the seedlings treated by composition 3, 2-butoxy ethanol, were significantly shorter than the other seedlings. The presence of roots was 87% in seedlings treated with composition 1, the first propylene glycol composition, but was significantly lower in seedlings treated with composition 3, butyoxy ethanol, and composition 5, THFA.

The results show that biomass, above-ground growth and root development were unaffected by treatment with compositions 1, 2 and 4, which were statistically the same and included propylene glycol and methoxy propanol as solvents. Corn seedling growth was significantly reduced by treatment of the seedlings with composition 3, 2-butoxy ethanol, which significantly reduced above-ground growth, biomass and root development. Seedlings treated with composition 5, in which the solvent was THFA, maintained similar above-ground growth and biomass compared to composition 1, in which the solvent was propylene glycol.

### Example 4

In this experiment, corn was planted and allowed to grow for nine days. The seedlings were then removed from the soil. The bottom portions of the plants were removed by cutting the seedlings in half at the connection point between the shoot and the seed. The cut seedlings were then placed in 19 ml of dilute treatment solutions in scintillation vials and allowed to grow in a growth chamber for one week. The treatment solutions included compositions 1 and 4 from Example 3, above, as well as additional solutions as shown below in Table 11. The growth conditions were 70 degrees Fahrenheit, 50% relative humidity and the lowest light level. The scintillation vials were filled with DI water every other day to ensure adequate moisture for the seedlings. After one week in the growth chamber, the seedlings were harvested and data was collected including whole plant fresh biomass, total plant growth, and the presence of roots. This process was repeated for nine seedlings for each treatment. The treatments are shown in Table 11 and the results are shown in Table 12, below. The results represent the treatment means as the average for the nine seedlings.

TABLE 11

| | | | Rate |
|---|---|---|---|
| Comp | Solvent | A.I. % weight | (fl oz/A) |
| Control | NA | NA | NA |
| 1 | PG | 0.0619% GA, 0.0124% CYT, | 5.3 |
| | | 0.1025% IBA | |
| 4 | 1-methoxy, | 0.0619% GA, 0.0124% CYT, | 5.3 |
| | 2-propanol | 0.1025% IBA | |
| | (MP) | | |
| 6 | PG | 0.035% GA, 0.09% CYT, | 5.3 |
| | | 0.045% IBA | |
| 7 | 50 PG/50 | 0.022% GA, 0.0045% CYT, | 5.3 |
| | 2-butoxy | 0.038% IBA | |
| | ethanol (BE) | | |
| 8 | 75 PG/25 BE | 0.022% GA, 0.0045% CYT, | 5.3 |
| | | 0.038% IBA | |
| 9 | 50 MP/50 BE | 0.022% GA, 0.0045% CYT, | 5.3 |
| | | 0.038% IBA | |

TABLE 12

| | | Plant | Root | Total Plant |
|---|---|---|---|---|
| | | length | Appearance | Fresh |
| Comp | Solvent | (cm) | (0/1)* | Biomass (g) |
| Control | NA | 18.22 | 1 | 0.936 |
| 1 | PG | 18.11 | 0 | 0.832 |
| 4 | 1-methoxy, | 18.39 | 0.2 | 0.824 |
| | 2-propanol | | | |
| | (MP) | | | |
| 6 | PG | 16.11 | 0 | 0.786 |
| 7 | 50 PG/50 | 15.28 | 0.1 | 0.669 |
| | 2-butoxy | | | |
| | ethanol (BE) | | | |
| 8 | 75 PG/25 BE | 18.5 | 0.7 | 0.834 |
| 9 | 50 MP/50 BE | 15.11 | 0.2 | 0.724 |

*Root appearance 0 is no roots, 1 is roots present.

The results were compared by Fisher's LSD at the 95% confidence level with a p value of 0.0001.

The results show that the untreated control seedlings and those treated with compositions 4 (1-methoxy, 2-propanol) and 8 (75% propylene glycol and 25% 2-butoxy ethanol) had the greatest plant length and were statistically greater than the remaining treatments. The untreated control seedlings also had the highest presence of roots and were statistically greater than all other treatments. However, seedlings treated with composition 8 (75% propylene glycol and 25% 2-butoxy ethanol) had 70% root presence which was statistically greater than the other experimental treatments. The untreated control seedlings also had the greatest total plant biomass. Seedlings treated with composition 4 (1-methoxy, 2-propanol), composition 1 (propylene glycol), and composition 6 (propylene glycol) were the second highest group for total biomass. The seedlings treated with compositions 7 (50% propylene glycol and 25% 2-butoxy ethanol) and 9 (50% 1-methoxy, 2-propanol and 25% 2-butoxy ethanol) were the lowest for total biomass. Over all three parameters, composition 8 (75% propylene glycol and 25% 2-butoxy ethanol) performed greater than the other experimental treatments.

### Example 5

Further experiments were performed using composition 1 from Examples 3 and 4 above and composition 7 and 8 from Example 4 above, as well as additional compositions as shown in table 13 below.

As in Example 4 above, corn was planted and allowed to grow for nine days. The seedlings were then removed from the soil. The bottom portions of the plants were removed by cutting the seedling in half at the connection point between the shoot and the seed. The cut seedlings were then placed in 19 ml of dilute treatment solutions in scintillation vials and allowed to grow in a growth chamber for one week. The growth conditions were 70 degrees Fahrenheit, 50% relative humidity and the lowest light level. The scintillation vials were filled with DI water every other day to ensure adequate moisture for the seedlings. After one week in the growth chamber, the seedlings were then harvested and data was collected including whole plant fresh biomass, total plant growth, and the presence of roots. This process was repeated for nine seedlings for each treatment. The treatments are shown in Table 13 and the results are shown in Table 14, below. The results represent the treatment means as the average for the nine seedlings.

TABLE 13

| | | | Rate |
|---|---|---|---|
| Comp | Solvent | A.I. % weight | (fl oz/A) |
| Untreated | NA | NA | NA |
| 1 | Propylene | 0.0619% GA, 0.0124% CYT, | 5.3 |
| | glycol (PG) | 0.1025% IBA | |
| 7 | 50/50 PG/ | 0.022% GA, 0.0045% CYT, | 5.3 |
| | 2-butoxy | 0.038% IBA | |
| | ethanol (BE) | | |
| 8 | 75/25 PG/BE | 0.022% GA, 0.0045% CYT, | 5.3 |
| | | 0.038% IBA | |
| 10 | 90/10 BE/water | 0.022% GA, 0.0045% CYT, | 5.3 |
| | | 0.038% IBA | |
| 11 | 80/20 BE/water | 0.022% GA, 0.0045% CYT, | 5.3 |
| | | 0.038% IBA | |
| 12 | 70/20/10 | 0.022% GA, 0.0045% CYT, | 5.3 |
| | PG/BE/water | 0.038% IBA | |

TABLE 14

| | | Plant | Root | Total Plant |
|---|---|---|---|---|
| | | length | Appearance | Fresh |
| Comp | Solvent | (cm) | (0/1)* | Biomass (g) |
| Control | NA | 23.17 | 1 | 1.17 |
| 1 | PG | 22.11 | 0.6 | 0.974 |
| 7 | 50 PG/50 BE | 22.44 | 0.2 | 0.95 |
| 8 | 75 PG/25 BE | 22.33 | 0.2 | 0.981 |
| 10 | 90 BE/10 water | 20.22 | 0 | 0.863 |
| 11 | 80 BE/20 water | 21.28 | 0.1 | 0.917 |
| 12 | 70 PG/20 BE/ | 21.33 | 0.1 | 0.943 |
| | 10 water | | | |

*Root appearance is binominal with 0 = no roots, 1 = roots present.

The results were compared by Fisher's LSD at the 95% confidence level with a p value of 0.0384 for plant length, 0.0001 for root appearance, and 0.0064 for total plant fresh biomass.

In this example, the untreated control seedlings and those treated with composition 8 (75% propylene glycol and 25% 2-butoxy ethanol), composition 1 (propylene glycol) and composition 7 (50% propylene glycol and 50% 2-butoxy ethanol) had the greatest plant length. The seedlings treated with composition 10 (90% 2-butoxy ethanol and 20% water) had the lowest plant growth and was statistically equal to composition 11 (90% 2-butoxy ethanol and 20% water) and composition 12 (70% propylene glycol, 20% 2-butoxy ethanol and 20% water). The untreated control seedlings had the highest presence of roots and was statistically greater than all other treatments. The seedlings treated with composition 1 (propylene glycol) had the second highest presence of roots but was statistically equal to those treated with composition 8 (75% propylene glycol and 25% 2-butoxy ethanol) and composition 7 (50% propylene glycol and 50% 2-butoxy ethanol). The untreated control seedlings also had a statistically greater total biomass than all other treatments.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or components used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A plant growth composition comprising:
a solvent composition, wherein the solvent comprises propylene glycol and 2-butoxy ethanol; and
an active component combination, wherein the active component combination is formulated to increase growth of a plant.

2. The plant growth composition of claim 1 wherein the solvent composition comprises about 50% or more propylene glycol and about 50% or less 2-butoxy ethanol.

3. The plant growth composition of claim 1 wherein the solvent composition comprises about 50% to about 90% propylene glycol and about 10% to about 50% 2-butoxy ethanol.

4. The composition of claim 1, wherein the active component combination comprises an amount of auxin, an amount of gibberellin, an amount of cytokinin, or a combination thereof.

5. The plant growth composition of claim 1, wherein the solvent composition comprises between about 95 wt % and about 99 wt % of the plant growth composition.

6. The plant growth composition of claim 1 further comprising an antioxidant and/or a preservative.

7. A plant growth composition comprising:
a solvent composition, wherein the solvent comprises propylene glycol and 2-butoxy ethanol; and
an active component combination comprising an amount of auxin, an amount of gibberellin, and an amount of cytokinin, wherein the active component combination is formulated to increase growth of a plant.

8. The plant growth composition of claim 6 further comprising an adjuvant, excipient, and/or surfactant.

9. The plant growth composition of claim 6 wherein the solvent composition comprises between about 50% and about 90% propylene glycol and between about 10% and about 50% 2-butoxy ethanol.

10. The plant growth composition of claim 6 wherein the solvent composition comprises about 50% propylene glycol and about 50% 2-butoxy ethanol.

11. The plant growth composition of claim 6 wherein the solvent composition comprises about 70% propylene glycol and about 30% 2-butoxy ethanol.

12. A method of improving plant growth, the method comprising:
applying a plant growth composition to plant seeds, the plant growth composition comprising:
a solvent composition comprising propylene glycol and 2-butyoxy ethanol; and
an active component combination; and
growing the plant seeds into mature plants.

13. The method of claim 12 wherein the solvent composition comprises about 50% or more propylene glycol and about 50% or less 2-butoxy ethanol.

14. The method of claim 12 wherein the solvent composition comprises about 50% to about 90% propylene glycol and about 10% to about 50% 2-butoxy ethanol.

15. The method of claim 14 wherein the active component combination comprises an amount of auxin, an amount of gibberellin, an amount of cytokinin, or a combination thereof.

16. The method of claim 15 wherein the solvent composition comprises between about 95 wt % and about 99 wt % of the plant growth composition.

17. The method of claim 12 wherein the seeds comprise soybean, corn, wheat, barley, or alfalfa seeds.

18. The method of claim 17 wherein applying the plant growth composition to plant seeds comprises applying the plant growth composition to the plant seeds prior to planting the plant seeds.

19. The method of claim 12 wherein applying the plant growth composition to plant seeds prior to planting comprises spraying or coating the plant seeds with the plant growth composition in a production setting.

20. The method of claim 12 wherein the solvent composition comprises about 70% to about 80% propylene glycol and about 20% to about 30% 2-butoxy ethanol.
